(19) United States
(12) Patent Application Publication
(10) Pub. No.: US 2023/0417556 A1
(43) Pub. Date: Dec. 28, 2023

(54) GUIDE DISPLAY CONTROL APPARATUS, GUIDE DISPLAY CONTROL METHOD, AND ROUTE GUIDING SYSTEM

(71) Applicant: Mitsubishi Electric Corporation, Tokyo (JP)

(72) Inventors: Saki MATSUI, Tokyo (JP); Reiko SAKATA, Tokyo (JP); Tatsunari KATAOKA, Tokyo (JP); Atsushi SHIMADA, Tokyo (JP); Naoki FURUHATA, Tokyo (JP)

(73) Assignee: Mitsubishi Electric Corporation, Tokyo (JP)

(21) Appl. No.: 18/367,504

(22) Filed: Sep. 13, 2023

Related U.S. Application Data
(63) Continuation of application No. PCT/JP2021/012905, filed on Mar. 26, 2021.

(51) Int. Cl. G01C 21/20; G06Q 10/0631; G07C 9/25; G07C 9/27; G07C 9/28; G06Q 90/00

(52) U.S. Cl. CPC G01C 21/206; G06Q 10/063114; G07C 9/25; G07C 9/27; G07C 9/28; G06Q 90/20; G06Q 50/265

(57) ABSTRACT

A guide display control apparatus includes: a detection signal obtaining unit to obtain a detection signal including identification information of a facility user who has entered a monitoring area from an approach detector that detects entry of the facility user into the monitoring area; a schedule obtaining unit to obtain a schedule indicating a visit order to a plurality of destinations, the schedule being associated with the identification information included in the detection signal obtained; a next destination specifying unit to specify a next destination in the visit order among destinations that the facility user has not visited yet in the plurality of destinations on the basis of the schedule obtained; and a display data generating unit to search for a route from the monitoring area to the next destination specified by the next destination specifying unit and generate display data for displaying a guide diagram of the route.

### CROSS-REFERENCE TO RELATED APPLICATION

The present application is a continuation of International Application No. PCT/JP2021/012905, filed Mar. 26, 2021, which is incorporated herein by reference in its entirety.

### TECHNICAL FIELD

The present disclosure relates to a guide display control apparatus, a guide display control method, and a route guiding system.

### BACKGROUND ART

As a technology for guiding a facility user who holds a mobile terminal until the facility user reaches a destination in the facility, there is a guide apparatus disclosed in Patent Literature 1. As guidance about a route to a destination, the guide apparatus projects an arrow indicating a direction in which the facility user should proceed on a floor surface of the facility at a branch point in the middle of the route to the destination.

### CITATION LIST

### Patent Literatures

Patent Literature 1: JP 2007-147300 A

### SUMMARY OF INVENTION

### Technical Problem

In the guide apparatus disclosed in Patent Literature 1, when there is a plurality of destinations to be visited by one facility user in a certain facility (hereinafter, such destinations are simply referred to as “a plurality of destinations”) and a visit order to the plurality of destinations is determined, routes to the destinations are not shown in the visit order. Therefore, in the guide apparatus, there is a problem that when there is a plurality of destinations whose visit order is determined, one facility user who should visit the destinations may not be able to visit the destinations in the visit order.

The present disclosure has been made to solve the above problem, and an object thereof is to provide a guide display control apparatus and a guide display control method capable of showing a route to each of a plurality of destinations in a visit order.

### Solution to Problem

A guide display control apparatus according to the present disclosure includes: detection signal obtaining circuitry to obtain a detection signal including identification information of a facility user who has entered one of monitoring areas in each of which a corresponding one of approach detectors is installed, from one of the approach detectors each of which is to detect entry of the facility user into a corresponding one of the monitoring areas, the approach detectors having respective device numbers different from each other, the detection signal further including one of the device numbers, the one of the approach detectors which has detected entry of the facility user having the one of the device numbers; schedule obtaining circuitry to obtain a schedule indicating a visit order to destinations, the schedule being associated with the identification information included in the detection signal obtained by the detection signal obtaining circuitry; next destination specifying circuitry to specify a next destination in the visit order among at least one of the destinations that has not been visited by the facility user yet on a basis of the schedule obtained by the schedule obtaining circuitry, progress status of the schedule stored in an internal memory, and the one of the device numbers which is included in the detection signal obtained by the detection signal obtaining circuitry, and to update the progress status in such a way as to indicate that a destination before the specified destination in the visit order has been visited; and display data generating circuitry to search for a route from the one of the monitoring areas to the next destination specified by the next destination specifying circuitry and generate display data for displaying a guide diagram of the route, the one of the monitoring areas being a detection target of the one of the approach detectors which has the one of the device numbers which is included in the detection signal obtained by the detection signal obtaining circuitry.

### Advantageous Effects of Invention

According to the present disclosure, it is possible to show routes to a plurality of destinations in a visit order.

### BRIEF DESCRIPTION OF DRAWINGS

FIG. 1 is a configuration diagram illustrating a route guiding system according to a first embodiment.

FIG. 2 is a configuration diagram illustrating a guide display control apparatus 2 according to the first embodiment.

FIG. 3 is a hardware configuration diagram illustrating hardware of the guide display control apparatus 2 according to the first embodiment.

FIG. 4 is a hardware configuration diagram of a computer in a case where the guide display control apparatus 2 is implemented by software, firmware, or the like.

FIG. 5 is a flowchart illustrating a guide display control method that is a processing procedure performed in the guide display control apparatus 2.

FIG. 6 is an explanatory diagram illustrating an example of icons stored in an icon storage unit 21c.

FIG. 7 is an explanatory diagram illustrating an example of a guide diagram.

FIG. 8 is a configuration diagram illustrating a guide display control apparatus 2 according to a second embodiment.

FIG. 9 is a hardware configuration diagram illustrating hardware of the guide display control apparatus 2 according to the second embodiment.

FIG. 10 is an explanatory diagram illustrating an example of an icon representing a facility user.

FIG. 11 is an explanatory diagram illustrating an example of a guide diagram.

FIG. 12 is an explanatory diagram illustrating an example of the guide diagram.

FIG. 13 is a configuration diagram illustrating a route guiding system according to a third embodiment.

FIG. 14 is a configuration diagram illustrating a guide display control apparatus 2 according to the third embodiment.

FIG. 15 is a hardware configuration diagram illustrating hardware of the guide display control apparatus 2 according to the third embodiment.

### DESCRIPTION OF EMBODIMENTS

Hereinafter, in order to describe the present disclosure in more detail, modes for carrying out the present disclosure will be described with reference to the accompanying drawings.

### First Embodiment

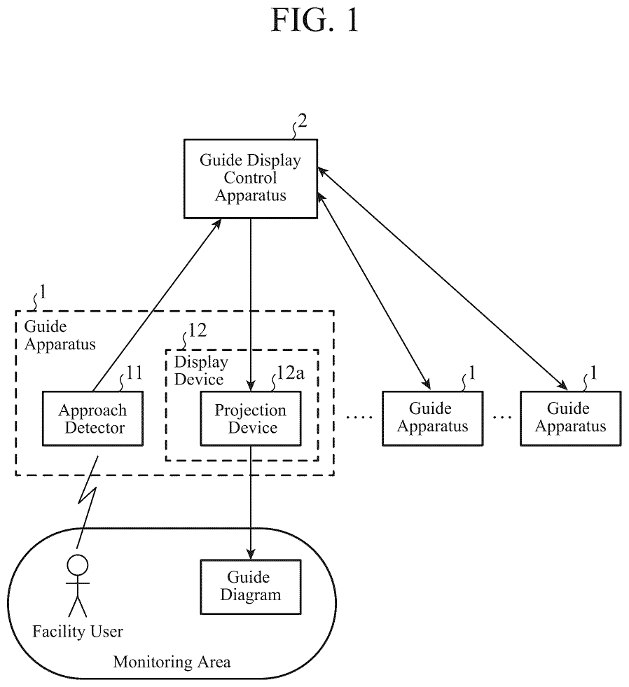

FIG. 1 is a configuration diagram illustrating a route guiding system according to a first embodiment.

The route guiding system illustrated in FIG. 1 includes a guide apparatus 1 and a guide display control apparatus 2.

The guide apparatus 1 includes an approach detector 11 and a display device 12.

The guide apparatus 1 performs entry detection processing of detecting entry of a facility user into a monitoring area. The monitoring area is an area where the guide apparatus 1 monitors the entrance of the facility user, and is, for example, an area including a branch point in the facility. Specifically, it is an area including an intersection where passages in the facility intersect. The facility here is not limited to a facility in one building, and includes a composite facility in which a plurality of buildings is present in the same site.

The guide apparatus 1 receives a radio wave or the like including identification information of the facility user from a possessed object of the facility user who has entered the monitoring area, and outputs a detection signal including the identification information to the guide display control apparatus 2.

The guide apparatus 1 displays a guide diagram of a route in accordance with display data output from the guide display control apparatus 2.

The possessed object of the facility user includes a radio frequency identification (RFID) tag or a mobile terminal.

The approach detector 11 is implemented by, for example, a receiver and a transmitter.

When the possessed object of the facility user is, for example, an RFID tag, the approach detector 11 receives a radio wave transmitted from the RFID tag when the facility user enters the monitoring area and it becomes possible to receive the radio wave. The radio wave includes the identification information of the facility user.

When the possessed object of the facility user is, for example, a mobile terminal, the approach detector 11 receives a radio wave of a near field communication system transmitted from the mobile terminal when the facility user enters the monitoring area and it becomes possible to receive the radio wave. The radio wave includes the identification information of the facility user.

When the approach detector 11 can receive the radio wave transmitted from the possessed object of the facility user, the approach detector 11 determines that the facility user has entered the monitoring area, and outputs a detection signal including the identification information of the facility user to the guide display control apparatus 2.

Since a plurality of guide apparatuses 1 is installed in the facility, the detection signal output from the approach detector 11 includes a device number indicating the guide apparatus 1 to which the approach detector 11 belongs in addition to the identification information of the facility user.

In the route guiding system illustrated in FIG. 1, the approach detector 11 receives a radio wave including the identification information of the facility user from the possessed object of the facility user, and outputs a detection signal including the identification information included in the radio wave to the guide display control apparatus 2. However, this is merely an example, and the approach detector 11 includes a camera that captures an image of the face of the facility user, and specifies the facility user by performing face authentication processing of the facility user on the basis of the image captured by the camera. Then, the approach detector 11 may output a detection signal including the identification information of the specified facility user to the guide display control apparatus 2.

The display device 12 displays the guide diagram in accordance with the display data output from the guide display control apparatus 2.

That is, the display device 12 includes a projection device 12a, and the projection device 12a projects the guide diagram on a floor surface or the like of the monitoring area in accordance with the display data output from the guide display control apparatus 2.

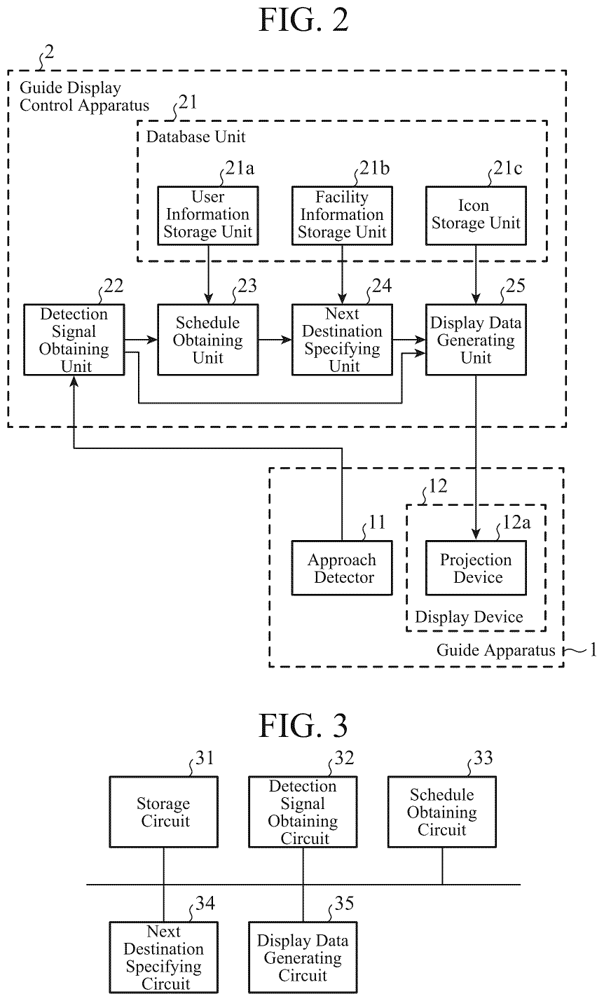

FIG. 2 is a configuration diagram illustrating the guide display control apparatus 2 according to the first embodiment.

FIG. 3 is a hardware configuration diagram illustrating hardware of the guide display control apparatus 2 according to the first embodiment.

The guide display control apparatus 2 illustrated in FIG. 2 includes a database unit 21, a detection signal obtaining unit 22, a schedule obtaining unit 23, a next destination specifying unit 24, and a display data generating unit 25.

The database unit 21 is implemented by, for example, a storage circuit 31 illustrated in FIG. 3.

The database unit 21 includes a user information storage unit 21a, a facility information storage unit 21b, and an icon storage unit 21c.

Pieces of identification information of a plurality of facility users are registered in the user information storage unit 21a.

The user information storage unit 21a stores schedules associated with the respective pieces of identification information. The schedule is information indicating the visit order to a plurality of destinations.

In a case where the facility is, for example, a hospital, the facility information storage unit 21b stores map data indicating each of the positions of a plurality of visiting departments of the hospital and passages in the hospital.

If the facility is, for example, a shopping mall, the facility information storage unit 21b stores map data indicating each of the positions of a plurality of stores of the shopping mall and passages in the shopping mall.

In a case where the facility is, for example, an airport, the facility information storage unit 21b stores map data indicating each of the positions of check-in counters, baggage inspection areas, boarding gates, stores, banks, and the like of the airport, and passages in the airport.

The icon storage unit 21c stores an arrow icon or the like to be used for generating a guide diagram.

The detection signal obtaining unit 22 is implemented by, for example, a detection signal obtaining circuit 32 illustrated in FIG. 3.

The detection signal obtaining unit 22 obtains a detection signal output from the approach detector 11 of the guide apparatus 1.

The detection signal obtaining unit 22 outputs the identification information included in the detection signal to the schedule obtaining unit 23, and outputs the device number included in the detection signal to the display data generating unit 25.

The schedule obtaining unit 23 is implemented by, for example, a schedule obtaining circuit 33 illustrated in FIG. 3.

The schedule obtaining unit 23 obtains identification information from the detection signal obtaining unit 22.

The schedule obtaining unit 23 obtains a schedule associated with the identification information from the user information storage unit 21a.

The schedule obtaining unit 23 outputs the schedule to the next destination specifying unit 24.

The next destination specifying unit 24 is implemented by, for example, a next destination specifying circuit 34 shown in FIG. 3.

The next destination specifying unit 24 obtains a schedule from the schedule obtaining unit 23.

On the basis of the schedule, the next destination specifying unit 24 specifies the next destination in the visit order among destinations that the facility user has not visited yet in a plurality of destinations.

The next destination specifying unit 24 outputs destination information indicating the specified next destination to the display data generating unit 25.

The display data generating unit 25 is implemented by, for example, a display data generating circuit 35 illustrated in FIG. 3.

The display data generating unit 25 obtains destination information from the next destination specifying unit 24, and obtains a device number from the detection signal obtaining unit 22.

By referring to the map data stored in the facility information storage unit 21b, the display data generating unit 25 searches for a route from the monitoring area of the guide apparatus 1 indicated by the device number to the next destination indicated by the destination information. An internal memory of the display data generating unit 25 stores the position of the monitoring area indicated by the device number.

On the basis of the route search result, the display data generating unit 25 generates display data for displaying a guide diagram of a route to the next destination using an icon stored in the icon storage unit 21c.

The display data generating unit 25 outputs the display data to the display device 12 of the guide apparatus 1.

In FIG. 2, it is assumed that each of the database unit 21, the detection signal obtaining unit 22, the schedule obtaining unit 23, the next destination specifying unit 24, and the display data generating unit 25, which are components of the guide display control apparatus 2, is implemented by dedicated hardware as illustrated in FIG. 3. That is, it is assumed that the guide display control apparatus 2 is implemented by the storage circuit 31, the detection signal obtaining circuit 32, the schedule obtaining circuit 33, the next destination specifying circuit 34, and the display data generating circuit 35.

Here, the storage circuit 31 corresponds to, for example, a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disk, a mini disk, or a digital versatile disc (DVD).

Further, each of the detection signal obtaining circuit 32, the schedule obtaining circuit 33, the next destination specifying circuit 34, and the display data generating circuit 35 corresponds to, for example, a single circuit, a composite circuit, a programmed processor, a parallel-programmed processor, an application specific integrated circuit (ASIC), a field-programmable gate array (FPGA), or a combination thereof.

The components of the guide display control apparatus 2 are not limited to those implemented by dedicated hardware, and the guide display control apparatus 2 may be implemented by software, firmware, or a combination of software and firmware.

The software or firmware is stored in a memory of a computer as a program. The computer means hardware that executes a program, and corresponds to, for example, a central processing unit (CPU), a central processing device, a processing device, an arithmetic device, a microprocessor, a microcomputer, a processor, or a digital signal processor (DSP).

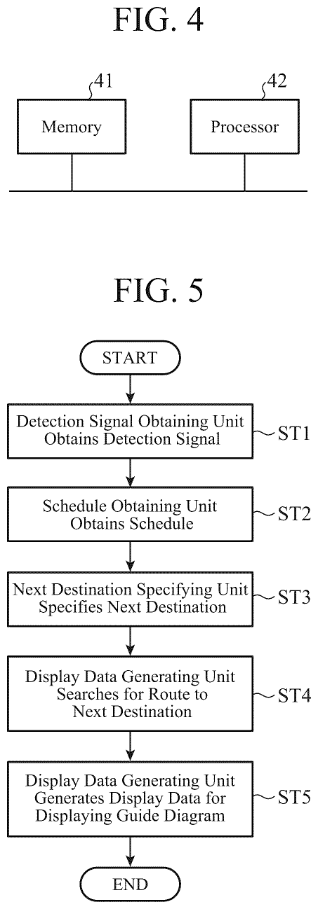

FIG. 4 is a hardware configuration diagram of a computer in a case where the guide display control apparatus 2 is implemented by software, firmware, or the like.

When the guide display control apparatus 2 is implemented by software, firmware, or the like, the database unit 21 is formed on a memory 41 of the computer. A program for causing the computer to execute each processing procedure performed in the detection signal obtaining unit 22, the schedule obtaining unit 23, the next destination specifying unit 24, and the display data generating unit 25 is stored in the memory 41. Then, a processor 42 of the computer executes the program stored in the memory 41.

Further, FIG. 3 illustrates an example in which each of the components of the guide display control apparatus 2 is implemented by dedicated hardware, and FIG. 4 illustrates an example in which the guide display control apparatus 2 is implemented by software, firmware, or the like. However, this is merely an example, and some components in the guide display control apparatus 2 may be implemented by dedicated hardware, and the remaining components may be implemented by software, firmware, or the like.

Next, the operation of the route guiding system illustrated in FIG. 1 will be described.

FIG. 5 is a flowchart illustrating a guide display control method which is a processing procedure performed in the guide display control apparatus 2.

In the route guiding system illustrated in FIG. 1, an example will be described in which a user of a facility is, for example, a facility user U1, identification information of the facility user U1 is U1-12345, and a facility which the facility user U1 uses is an airport.

In the route guiding system illustrated in FIG. 1, an example will be described in which a schedule indicating that the visit order in the airport of the facility user U1 is the order of a check-in counter, a bank, a baggage inspection area, and a boarding gate is stored in the user information storage unit 21a.

The guide apparatus 1 is installed, for example, in the vicinity of an entrance of an airport terminal building. Further, the guide apparatus 1 is installed at a branch point of a passage to each destination, in the vicinity of an entrance or exit of each destination, or the like.

For example, the approach detector 11 of the guide apparatus 1 whose monitoring area is the vicinity of the entrance of the airport terminal building receives a radio wave transmitted from an RFID tag or the like owned by the facility user U1 when the facility user U1 enters the monitoring area.

Upon receiving the radio wave transmitted from the RFID tag or the like, the approach detector 11 determines that the facility user U1 has entered the monitoring area, and obtains the identification information “U1-12345” of the facility user U1 included in the received radio wave.

The approach detector 11 outputs a detection signal including the identification information “U1-12345” of the facility user U1 and the device number indicating the guide apparatus 1 to which the approach detector belongs to the guide display control apparatus 2.

For example, the approach detector 11 belonging to the guide apparatus 1 whose monitoring area is the vicinity of an entrance of the airport terminal building outputs a detection signal including a device number “A001” to the guide display control apparatus 2.

For example, the approach detector 11 belonging to the guide apparatus 1 whose monitoring area is the vicinity of a check-in counter outputs a detection signal including a device number “A002” to the guide display control apparatus 2.

For example, the approach detector 11 belonging to the guide apparatus 1 whose monitoring area is the vicinity of a bank outputs a detection signal including a device number “A003” to the guide display control apparatus 2.

For example, the approach detector 11 belonging to the guide apparatus 1 whose monitoring area is the vicinity of a baggage inspection area outputs a detection signal including a device number “A004” to the guide display control apparatus 2.

For example, the approach detector 11 belonging to the guide apparatus 1 whose monitoring area is the vicinity of a boarding gate outputs a detection signal including a device number “A005” to the guide display control apparatus 2.

The approach detector 11 belonging to the guide apparatus 1 whose monitoring area is a branch point of the passage to each destination outputs a detection signal including a device number different from the above “A001” to “A005” to the guide display control apparatus 2.

The detection signal obtaining unit 22 of the guide display control apparatus 2 obtains a detection signal from the approach detector 11 of the guide apparatus 1 (step ST1 in FIG. 5).

The detection signal obtaining unit 22 outputs the identification information “U1-12345” included in the detection signal to the schedule obtaining unit 23, and outputs the device number included in the detection signal to each of the schedule obtaining unit 23 and the display data generating unit 25.

The schedule obtaining unit 23 obtains each of the identification information “U1-12345” and the device number from the detection signal obtaining unit 22.

The schedule obtaining unit 23 obtains a schedule associated with the identification information “U1-12345” from the user information storage unit 21a (step ST2 in FIG. 5).

The schedule obtaining unit 23 outputs each of the schedule and the device number to the next destination specifying unit 24.

The next destination specifying unit 24 obtains each of the schedule and the device number from the schedule obtaining unit 23.

On the basis of the schedule, the next destination specifying unit 24 specifies the next destination in the visit order among destinations that the facility user U1 has not visited yet in the plurality of destinations (step ST3 in FIG. 5).

In an internal memory of the next destination specifying unit 24, the progress status of the schedule associated with the identification information “U1-12345” is stored. Under a situation where the device number is “A001” and the facility user U1 has not visited any destination yet, a progress status indicating that the facility user U1 has not visited any destination is stored in the internal memory. When the progress status stored in the internal memory indicates that the user has not visited any destination, the next destination specifying unit 24 specifies a check-in counter as the next destination, the check-in counter being the first destination in the visit order.

When the device number is “A002”, the facility user U1 has already visited the check-in counter. Thus, the next destination specifying unit 24 updates the progress status stored in the internal memory in such a way as to indicate that the check-in counter has been visited. In this case, the next destination specifying unit 24 specifies, as the next destination, a bank which is the second destination in the visit order.

When the device number is “A003”, the facility user U1 has already visited the bank. Thus, the next destination specifying unit 24 updates the progress status stored in the internal memory in such a way as to indicate that each of the check-in counter and the bank has been visited. In this case, the next destination specifying unit 24 specifies, as the next destination, a baggage inspection area which is the third destination in the visit order.

When the device number is “A004”, the facility user U1 has already visited the baggage inspection area. Thus, the next destination specifying unit 24 updates the progress status stored in the internal memory in such a way as to indicate that each of the check-in counter, the bank, and the baggage inspection area has been visited. In this case, the next destination specifying unit 24 specifies, as the next destination, a boarding gate which is the fourth destination in the visit order.

The next destination specifying unit 24 outputs destination information indicating the specified next destination to the display data generating unit 25.

The display data generating unit 25 obtains destination information from the next destination specifying unit 24, and obtains a device number from the detection signal obtaining unit 22.

By referring to the map data stored in the facility information storage unit 21b, the display data generating unit 25 searches for a route from the monitoring area of the guide apparatus 1 indicated by the device number to the next destination indicated by the destination information (step ST4 in FIG. 5).

For example, when the device number is “A001” and the next destination is the check-in counter, the display data generating unit 25 searches for a route from the vicinity of the entrance of the airport terminal building to the check-in counter.

For example, when the device number is “A002” and the next destination is a bank, the display data generating unit 25 searches for a route from the check-in counter to the bank.

For example, when the device number is “A003” and the next destination is the baggage inspection area, the display data generating unit 25 searches for a route from the bank to the baggage inspection area.

For example, when the device number is “A004” and the next destination is the boarding gate, the display data generating unit 25 searches for a route from the baggage inspection area to the boarding gate.

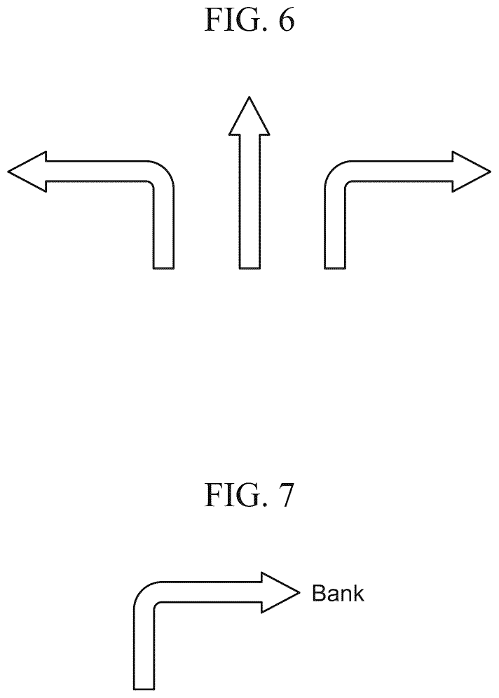

FIG. 6 is an explanatory diagram illustrating an example of icons stored in the icon storage unit 21c.

The icon illustrated in FIG. 6 is an arrow icon indicating a route to the destination.

On the basis of the route search result, the display data generating unit 25 generates display data for displaying a guide diagram of a route to the next destination using the icon stored in the icon storage unit 21c (step ST5 in FIG. 5).

The display data generating unit 25 outputs the display data to the projection device 12a of the guide apparatus 1.

For example, when the device number is “A001” and the direction of the route from the vicinity of the entrance of the airport terminal building to the check-in counter is, for example, a straight ahead direction, the display data generating unit 25 selects an arrow icon whose arrow direction indicates the straight ahead direction (hereinafter referred to as a “straight arrow icon”) from among a plurality of arrow icons stored in the icon storage unit 21c. The display data generating unit 25 generates display data for displaying a guide diagram of the route using the straight arrow icon.

For example, when the device number is “A002” and the direction of the route from the check-in counter to the bank is, for example, a right turn direction, the display data generating unit 25 selects an arrow icon whose arrow direction indicates the right turn direction (hereinafter referred to as a “right turn arrow icon”) from among the plurality of arrow icons stored in the icon storage unit 21c. The display data generating unit 25 generates display data for displaying a guide diagram of the route using the right turn arrow icon.

For example, when the device number is “A003” and the direction of the route from the bank to the baggage inspection area is, for example, a left turn direction, the display data generating unit 25 selects an arrow icon whose arrow direction indicates the left turn direction (hereinafter referred to as a “left turn arrow icon”) from among the plurality of arrow icons stored in the icon storage unit 21c. The display data generating unit 25 generates display data for displaying a guide diagram of the route using the left turn arrow icon.

For example, when the device number is “A004” and the direction of the route from the baggage inspection area to the boarding gate is, for example, a straight ahead direction, the display data generating unit 25 selects the straight arrow icon from among the plurality of arrow icons stored in the icon storage unit 21c. The display data generating unit 25 generates display data for displaying a guide diagram of the route using the straight arrow icon.

FIG. 7 is an explanatory diagram illustrating an example of a guide diagram.

In the example of FIG. 7, the monitoring area is the check-in counter, and a guide diagram of a route from the check-in counter to the bank is illustrated.

The projection device 12a obtains display data from the display data generating unit 25.

As illustrated in FIG. 7, the projection device 12a projects the guide diagram onto a floor surface or the like of the monitoring area in accordance with the display data.

The facility user U1 can see the route to the next destination by looking at the guide diagram projected on the floor surface or the like of the monitoring area.

In the first embodiment described above, the guide display control apparatus 2 includes: the detection signal obtaining unit 22 to obtain a detection signal including identification information of a facility user who has entered one of the monitoring areas from one of the approach detectors 11 that detects entry of the facility user into the one of the monitoring areas; the schedule obtaining unit 23 to obtain a schedule indicating a visit order to destinations, the schedule being associated with the identification information included in the detection signal obtained by the detection signal obtaining unit 22; the next destination specifying unit 24 to specify a next destination in the visit order among at least one of the destinations that has not been visited by the facility user yet on the basis of the schedule obtained by the schedule obtaining unit 23; and the display data generating unit 25 to search for a route from the one of the monitoring areas to the next destination specified by the next destination specifying unit 24 and generate display data for displaying a guide diagram of the route. Therefore, the guide display control apparatus 2 can show the route to each of the plurality of destinations in the visit order.

### Second Embodiment

In a second embodiment, a guide display control apparatus 2 in which a display data generating unit 26 generates display data for displaying a guide diagram including an icon representing a facility user will be described.

The configuration of a route guiding system according to the second embodiment is similar to the configuration of the route guiding system according to the first embodiment, and a configuration diagram illustrating the route guiding system according to the second embodiment is FIG. 1.

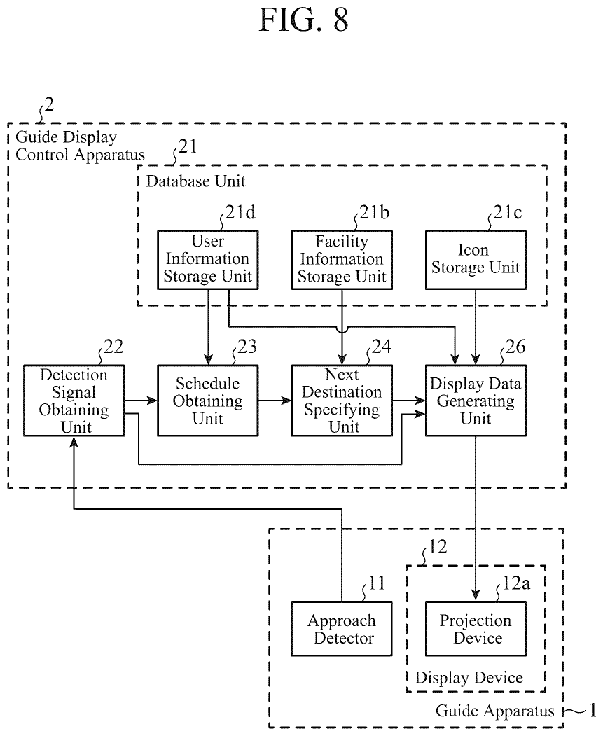

FIG. 8 is a configuration diagram illustrating the guide display control apparatus 2 according to the second embodiment.

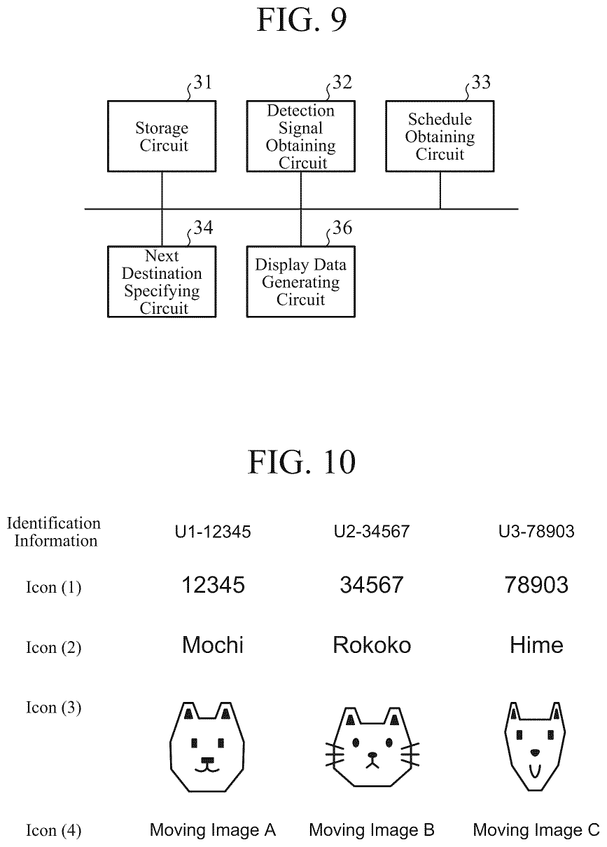

FIG. 9 is a hardware configuration diagram illustrating hardware of the guide display control apparatus 2 according to the second embodiment.

The guide display control apparatus 2 illustrated in FIG. 8 includes the database unit 21, the detection signal obtaining unit 22, the schedule obtaining unit 23, the next destination specifying unit 24, and the display data generating unit 26.

The database unit 21 includes a user information storage unit 21d, the facility information storage unit 21b, and the icon storage unit 21c.

As in the user information storage unit 21a illustrated in FIG. 2, pieces of identification information of a plurality of facility users are registered in the user information storage unit 21d.

The user information storage unit 21d stores not only schedules associated with the respective pieces of identification information but also icons which represent the facility users and which are associated with the respective pieces of identification information.

The icon representing the facility user includes a number representing the facility user, a nickname of the facility user, a character image representing the facility user, or a moving image representing the facility user.

FIG. 10 is an explanatory diagram illustrating an example of the icon representing the facility user.

FIG. 10 illustrates an example of icons associated with the identification information “U1-12345”, “U2-34567”, and “U3-78903”.

An icon (1) is an icon of a number representing the facility user, and an icon (2) is an icon of a nickname of the facility user. An icon (3) is an icon of a character image representing the facility user, and an icon (4) is an icon of a moving image representing the facility user. Although a specific example of the icon of the moving image is not illustrated, any moving image may be used as long as the moving image is different for each facility user.

The display data generating unit 26 is implemented by, for example, a display data generating circuit 36 illustrated in FIG. 9.

The display data generating unit 26 obtains destination information from the next destination specifying unit 24, and obtains a detection signal from the detection signal obtaining unit 22.

By referring to the map data stored in the facility information storage unit 21b, the display data generating unit 26 searches for a route from the monitoring area of the guide apparatus 1 indicated by the device number included in the detection signal to the next destination indicated by the destination information. An internal memory of the display data generating unit 26 stores the position of the monitoring area indicated by the device number.

On the basis of the route search result, the display data generating unit 26 generates display data for displaying a guide diagram of a route to the next destination using the icon stored in the icon storage unit 21c, as does the display data generating unit 25 illustrated in FIG. 2.

Unlike the display data generating unit 25 illustrated in FIG. 2, when generating the display data, the display data generating unit 26 obtains an icon associated with the identification information included in the detection signal obtained by the detection signal obtaining unit 22 from the user information storage unit 21d, and generates the display data for displaying the guide diagram including the icon.

The display data generating unit 26 outputs the display data to the projection device 12a of the guide apparatus 1.

In FIG. 8, it is assumed that each of the database unit 21, the detection signal obtaining unit 22, the schedule obtaining unit 23, the next destination specifying unit 24, and the display data generating unit 26, which are components of the guide display control apparatus 2, is implemented by dedicated hardware as illustrated in FIG. 9. That is, it is assumed that the guide display control apparatus 2 is implemented by the storage circuit 31, the detection signal obtaining circuit 32, the schedule obtaining circuit 33, the next destination specifying circuit 34, and the display data generating circuit 36.

Each of the detection signal obtaining circuit 32, the schedule obtaining circuit 33, the next destination specifying circuit 34, and the display data generating circuit 36 corresponds to, for example, a single circuit, a composite circuit, a programmed processor, a parallel-programmed processor, an ASIC, an FPGA, or a combination thereof.

The components of the guide display control apparatus 2 are not limited to those implemented by dedicated hardware, and the guide display control apparatus 2 may be implemented by software, firmware, or a combination of software and firmware.

When the guide display control apparatus 2 is implemented by software, firmware, or the like, the database unit 21 is formed on the memory 41 of the computer. A program for causing the computer to execute each processing procedure performed in the detection signal obtaining unit 22, the schedule obtaining unit 23, the next destination specifying unit 24, and the display data generating unit 26 is stored in the memory 41 illustrated in FIG. 4. Then, the processor 42 illustrated in FIG. 4 executes the program stored in the memory 41.

Further, FIG. 9 illustrates an example in which each of the components of the guide display control apparatus 2 is implemented by dedicated hardware, and FIG. 4 illustrates an example in which the guide display control apparatus 2 is implemented by software, firmware, or the like. However, this is merely an example, and some components in the guide display control apparatus 2 may be implemented by dedicated hardware, and the remaining components may be implemented by software, firmware, or the like.

Next, the operation of the guide display control apparatus 2 illustrated in FIG. 8 will be described. It is substantially similar to that of the guide display control apparatus 2 illustrated in FIG. 2 except for the display data generating unit 26, and thus the operation of the display data generating unit 26 will be mainly described here.

In the guide display control apparatus 2 illustrated in FIG. 8, what is output from the detection signal obtaining unit 22 to the display data generating unit 26 is not the device number but the detection signal including both the identification information and the device number.

The display data generating unit 26 obtains destination information from the next destination specifying unit 24, and obtains the detection signal from the detection signal obtaining unit 22.

By referring to the map data stored in the facility information storage unit 21b, the display data generating unit 26 searches for a route from the monitoring area of the guide apparatus 1 indicated by the device number included in the detection signal to the next destination indicated by the destination information.

On the basis of the route search result, the display data generating unit 26 generates display data for displaying a guide diagram of a route to the next destination using the icon stored in the icon storage unit 21c, as does the display data generating unit 25 illustrated in FIG. 2.

However, unlike the display data generating unit 25 illustrated in FIG. 2, the display data generating unit 26 generates display data for displaying a guide diagram including an icon representing the facility user.

The display data generating unit 26 outputs the display data to the projection device 12a of the guide apparatus 1.

For example, when the device number is “A002” and the direction of a route from a check-in counter to a bank is, for example, a right turn direction, the display data generating unit 26 selects the right turn arrow icon from the plurality of arrow icons stored in the icon storage unit 21c. Further, when the identification information is “U1-12345”, one or more icons associated with the identification information “U1-12345” are selected from the icons (1) to (4) stored in the user information storage unit 21d.

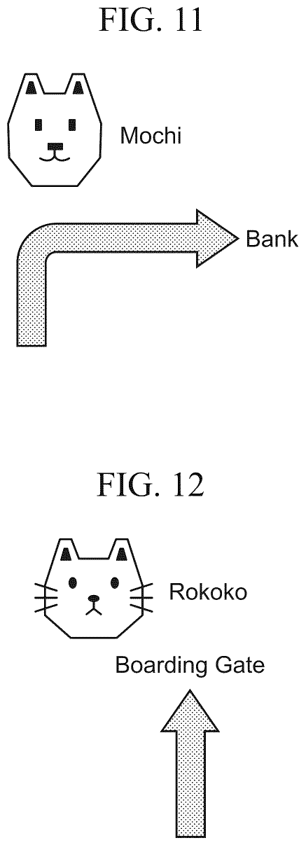

The display data generating unit 26 generates display data for displaying a guide diagram as illustrated in FIG. 11 using the right turn arrow icon and the one or more icons associated with the identification information “U1-12345”.

FIG. 11 is an explanatory diagram illustrating an example of a guide diagram.

In the example of FIG. 11, the identification information is “U1-12345”, the monitoring area is the check-in counter, and a guide diagram of the route from the check-in counter to the bank is illustrated.

The guide diagram illustrated in FIG. 11 illustrates an example in which each of the icon (2) and the icon (3) is used.

For example, when the device number is “A004” and the direction of a route from a baggage inspection area to a boarding gate is, for example, a straight ahead direction, the display data generating unit 26 selects the straight arrow icon from the plurality of arrow icons stored in the icon storage unit 21c. Further, when the identification information is “U2-34567”, one or more icons associated with the identification information “U2-34567” are selected from the icons (1) to (4) stored in the user information storage unit 21d.

The display data generating unit 26 generates display data for displaying a guide diagram as illustrated in FIG. 12 using the straight arrow icon and the one or more icons associated with the identification information “U2-34567”.

FIG. 12 is an explanatory diagram illustrating an example of a guide diagram.

In the example of FIG. 12, the identification information is “U2-34567”, the monitoring area is the baggage inspection area, and a guide diagram of the route from the baggage inspection area to the boarding gate is illustrated.

The guide diagram illustrated in FIG. 12 illustrates an example in which each of the icon (2) and the icon (3) is used.

The projection device 12a obtains display data from the display data generating unit 26.

As illustrated in FIG. 11 or 12, the projection device 12a projects the guide diagram onto a floor surface or the like of the monitoring area in accordance with the display data.

The facility user can see the route to the next destination by looking at the guide diagram projected on the floor surface or the like of the monitoring area.

In the second embodiment described above, the guide display control apparatus 2 illustrated in FIG. 8 is configured in such a way that the display data generating unit 26 obtains the icon representing the facility user who has entered the monitoring area, and generates the display data for displaying the guide diagram including the icon, the icon being associated with the identification information included in the detection signal obtained by the detection signal obtaining unit 22. Therefore, as is the guide display control apparatus 2 illustrated in FIG. 2, the guide display control apparatus 2 illustrated in FIG. 8 is capable of showing the route to each of the plurality of destinations in the visit order, and enables the facility user to recognize to whom the guide diagram being displayed is addressed without displaying the personal information of the facility user.

### Third Embodiment

In a third embodiment, a guide display control apparatus 2 including an associating unit 27 that obtains identification information of a facility user and a schedule indicating a visit order to a plurality of destinations, and associates the obtained identification information with the obtained schedule will be described.

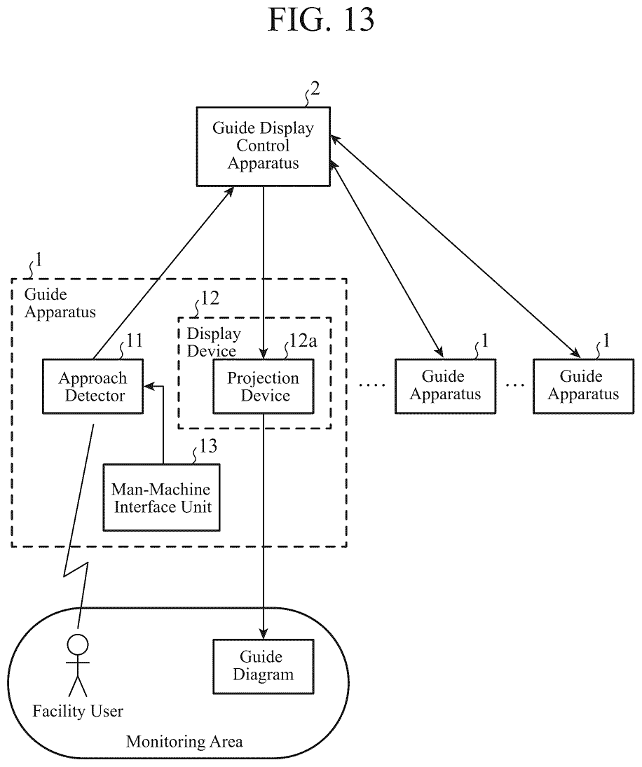

FIG. 13 is a configuration diagram illustrating a route guiding system according to the third embodiment.

The route guiding system illustrated in FIG. 13 includes the guide apparatus 1 and the guide display control apparatus 2.

The guide apparatus 1 includes the approach detector 11, the display device 12, and a man-machine interface unit 13.

The man-machine interface unit 13 is implemented by a keyboard, a mouse, a touch panel, or the like.

The man-machine interface unit 13 receives a setting operation of a schedule indicating a visit order to a plurality of destinations by the facility user, and outputs schedule information indicating the schedule to the approach detector 11.

When the schedule information is output from the man-machine interface unit 13, the approach detector 11 outputs a detection signal including the identification information of the facility user and the schedule information to the guide display control apparatus 2. The detection signal obtaining unit 22 of the guide display control apparatus 2 obtains the detection signal output from the approach detector 11. When the detection signal includes each of the identification information and the schedule information, the detection signal obtaining unit 22 outputs each of the identification information and the schedule information to the associating unit 27.

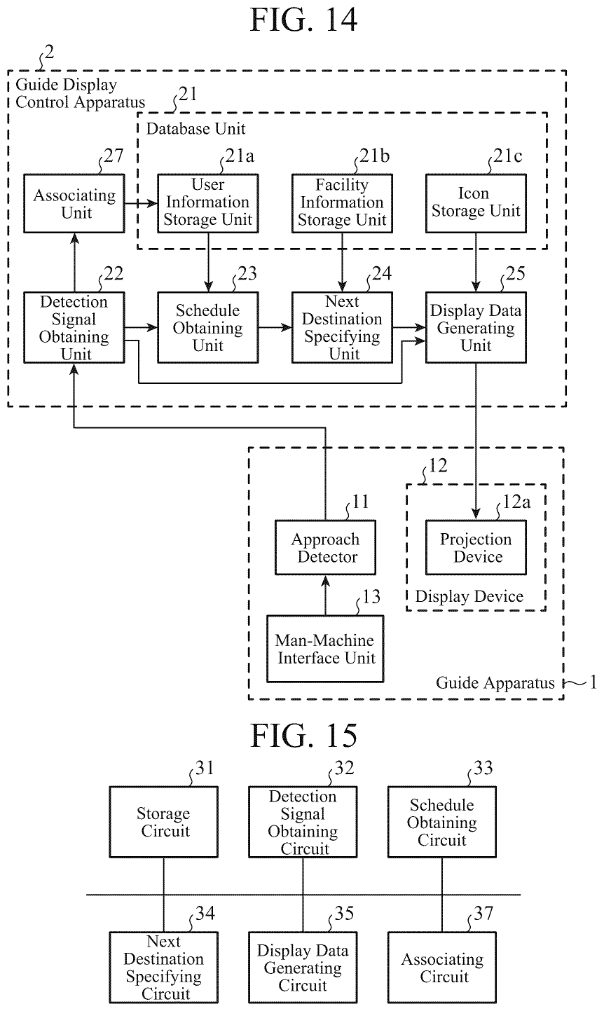

FIG. 14 is a configuration diagram illustrating the guide display control apparatus 2 according to the third embodiment.

FIG. 15 is a hardware configuration diagram illustrating hardware of the guide display control apparatus 2 according to the third embodiment.

In FIGS. 14 and 15, the same reference numerals as those in FIGS. 2 and 3 denote the same or corresponding components, and thus description thereof is omitted.

The guide display control apparatus 2 illustrated in FIG. 14 includes the database unit 21, the detection signal obtaining unit 22, the schedule obtaining unit 23, the next destination specifying unit 24, the display data generating unit 25, and the associating unit 27.

The associating unit 27 is implemented by, for example, an associating circuit 37 illustrated in FIG. 15.

The associating unit 27 obtains each of the identification information and the schedule information from the detection signal obtaining unit 22.

The associating unit 27 stores each of the identification information and the schedule information in the user information storage unit 21a.

In the guide display control apparatus 2 illustrated in FIG. 14, the associating unit 27 is applied to the guide display control apparatus 2 illustrated in FIG. 2. However, this is merely an example, and the associating unit 27 may be applied to the guide display control apparatus 2 illustrated in FIG. 8.

In FIG. 14, it is assumed that each of the database unit 21, the detection signal obtaining unit 22, the schedule obtaining unit 23, the next destination specifying unit 24, the display data generating unit 25, and the associating unit 27, which are components of the guide display control apparatus 2, is implemented by dedicated hardware as illustrated in FIG. 15. That is, it is assumed that the guide display control apparatus 2 is implemented by the storage circuit 31, the detection signal obtaining circuit 32, the schedule obtaining circuit 33, the next destination specifying circuit 34, the display data generating circuit 35, and the associating circuit 37.

Each of the detection signal obtaining circuit 32, the schedule obtaining circuit 33, the next destination specifying circuit 34, the display data generating circuit 35, and the associating circuit 37 corresponds to, for example, a single circuit, a composite circuit, a programmed processor, a parallel-programmed processor, an ASIC, an FPGA, or a combination thereof.

The components of the guide display control apparatus 2 are not limited to those implemented by dedicated hardware, and the guide display control apparatus 2 may be implemented by software, firmware, or a combination of software and firmware.

When the guide display control apparatus 2 is implemented by software, firmware, or the like, the database unit 21 is formed on the memory 41 of the computer. A program for causing the computer to execute each processing procedure in the detection signal obtaining unit 22, the schedule obtaining unit 23, the next destination specifying unit 24, the display data generating unit 25, and the associating unit 27 is stored in the memory 41 illustrated in FIG. 4. Then, the processor 42 illustrated in FIG. 4 executes the program stored in the memory 41.

Further, FIG. 15 illustrates an example in which each of the components of the guide display control apparatus 2 is implemented by dedicated hardware, and FIG. 4 illustrates an example in which the guide display control apparatus 2 is implemented by software, firmware, or the like. However, this is merely an example, and some components in the guide display control apparatus 2 may be implemented by dedicated hardware, and the remaining components may be implemented by software, firmware, or the like.

Next, the operation of the route guiding system illustrated in FIG. 13 will be described. It is similar to that of the route guiding system illustrated in FIG. 1 except for the man-machine interface unit 13 and the associating unit 27, and thus the operation of the man-machine interface unit 13 and the associating unit 27 will be mainly described here.

In the route guiding system illustrated in FIG. 13, the facility user U1 can freely set the schedule.

For example, the facility user U1 who has entered the monitoring area can set the schedule by operating the man-machine interface unit 13.

The man-machine interface unit 13 receives a setting operation of the schedule by the facility user U1 and outputs schedule information indicating the schedule to the approach detector 11.

When the approach detector 11 can receive the radio wave transmitted from the possessed object of the facility user, the approach detector 11 determines that the facility user has entered the monitoring area, and outputs a detection signal including identification information “U1-12345” of the facility user and the device number to the guide display control apparatus 2.

Further, upon receiving the schedule information from the man-machine interface unit 13, the approach detector 11 outputs a detection signal including the identification information “U1-12345” of the facility user U1 and the schedule information to the guide display control apparatus 2.

The detection signal obtaining unit 22 obtains the detection signal output from approach detector 11.

When the detection signal includes each of the identification information “U1-12345” and the device number, the detection signal obtaining unit 22 outputs each of the identification information “U1-12345” and the device number to the schedule obtaining unit 23, and outputs the device number to the display data generating unit 25.

When the detection signal includes each of the identification information “U1-12345” and the schedule information, the detection signal obtaining unit 22 outputs each of the identification information “U1-12345” and the schedule information to the associating unit 27.

The associating unit 27 obtains each of the identification information and the schedule information from the detection signal obtaining unit 22.

The associating unit 27 stores each of the identification information and the schedule information in the user information storage unit 21a.

The operation thereafter is similar to that of the route guiding system illustrated in FIG. 1, and thus detailed description thereof will be omitted.

In the above-described third embodiment, the guide display control apparatus 2 illustrated in FIG. 14 is configured to include the associating unit 27 that obtains the identification information of the facility user and the schedule indicating the visit order to the plurality of destinations, and associates the obtained identification information with the obtained schedule. Therefore, as is the guide display control apparatus 2 illustrated in FIG. 2, the guide display control apparatus 2 illustrated in FIG. 14 is capable of showing the route to each of the plurality of destinations in the visit order, and allows the facility user to set the schedule.

In the route guiding system illustrated in FIG. 13, the man-machine interface unit 13 receives a setting operation of the schedule and outputs schedule information indicating the schedule to the approach detector 11, and the approach detector 11 outputs a detection signal including the schedule information to the associating unit 27. However, this is merely an example. When the possessed object of the facility user is, for example, a mobile terminal and the associating unit 27 has a wireless communication function, the mobile terminal may transmit each of the identification information and the schedule information to the associating unit 27.

In the route guiding systems according to the first to third embodiments, the display device 12 includes the projection device 12a, and the projection device 12a projects the guide diagram on the floor surface or the like of the monitoring area in accordance with the display data. However, this is merely an example. The display device 12 may include, for example, an indicator having a display instead of the projection device 12a, and the indicator may display the guide diagram on the display in accordance with the display data.

In the guide display control apparatuses 2 according to the first to third embodiments, the display data generating unit 25 or the display data generating unit 26 generates display data for displaying the guide diagram. However, this is merely an example. The display data generating unit 25 or the display data generating unit 26 may generate voice data for outputting route guidance or the like by voice, and output the voice data to a voice output device, which is not illustrated, of the guide apparatus 1.

Note that, in the present disclosure, free combinations of the embodiments, modifications of any components of the embodiments, or omissions of any components in the embodiments are possible.

### INDUSTRIAL APPLICABILITY

The present disclosure is suitable for a guide display control apparatus, a guide display control method, and a route guiding system.

### REFERENCE SIGNS LIST

1: guide apparatus, 2: guide display control apparatus, 11: approach detector, 12: display device, 12a: projection device, 13: man-machine interface unit, 21: database unit, 21a, 21d: user information storage unit, 21b: facility information storage unit, 21c: icon storage unit, 22: detection signal obtaining unit, 23: schedule obtaining unit, 24: next destination specifying unit, 25, 26: display data generating unit, 27: associating unit, 31: storage circuit, 32: detection signal obtaining circuit, 33: schedule obtaining circuit, 34: next destination specifying circuit, 35, 36: display data generating circuit, 37: associating circuit, 41: memory, 42: processor

1. A guide display control apparatus comprising:
detection signal obtaining circuitry to obtain a detection signal including identification information of a facility user who has entered one of monitoring areas in each of which a corresponding one of approach detectors is installed, from one of the approach detectors each of which is to detect entry of the facility user into a corresponding one of the monitoring areas, the approach detectors having respective device numbers different from each other, the detection signal further including one of the device numbers, the one of the approach detectors which has detected entry of the facility user having the one of the device numbers;
schedule obtaining circuitry to obtain a schedule indicating a visit order to destinations, the schedule being associated with the identification information included in the detection signal obtained by the detection signal obtaining circuitry;
next destination specifying circuitry to specify a next destination in the visit order among at least one of the destinations that has not been visited by the facility user yet on a basis of the schedule obtained by the schedule obtaining circuitry, progress status of the schedule stored in an internal memory, and the one of the device numbers which is included in the detection signal obtained by the detection signal obtaining circuitry, and to update the progress status in such a way as to indicate that a destination before the specified destination in the visit order has been visited; and
display data generating circuitry to search for a route from the one of the monitoring areas to the next destination specified by the next destination specifying circuitry and generate display data for displaying a guide diagram of the route, the one of the monitoring areas being a detection target of the one of the approach detectors which has the one of the device numbers which is included in the detection signal obtained by the detection signal obtaining circuitry.

2. The guide display control apparatus according to claim 1, wherein the display data generating circuitry obtains an icon representing the facility user who has entered the one of the monitoring areas, and generates display data for displaying the guide diagram including the icon, the icon being associated with the identification information included in the detection signal obtained by the detection signal obtaining circuitry.

3. The guide display control apparatus according to claim 2, wherein the icon obtained by the display data generating circuitry is a number representing the facility user who has entered the one of the monitoring areas, a nickname of the facility user, a character image representing the facility user, or a moving image representing the facility user.

4. The guide display control apparatus according to claim 1, further comprising associating circuitry to obtain identification information of a facility user and a schedule indicating a visit order to destinations, and associate the obtained identification information with the obtained schedule.

5. A guide display control method comprising:
obtaining a detection signal including identification information of a facility user who has entered one of monitoring areas in each of which a corresponding one of approach detectors is installed, from one of the approach detectors each of which is to detect entry of the facility user into a corresponding one of the monitoring areas, the approach detectors having respective device numbers different from each other, the detection signal further including one of the device numbers, the one of the approach detectors which has detected entry of the facility user having the one of the device numbers;
obtaining a schedule indicating a visit order to destinations, the schedule being associated with the identification information included in the detection signal obtained;
specifying a next destination in the visit order among at least one of the destinations that has not been visited by the facility user yet on a basis of the schedule obtained, progress status of the schedule stored in an internal memory, and the one of the device numbers which is included in the detection signal obtained, and updating the progress status in such a way as to indicate that a destination before the specified destination in the visit order has been visited; and
searching for a route from the one of the monitoring areas to the next destination specified and generating display data for displaying a guide diagram of the route, the one of the monitoring areas being a detection target of the one of the approach detectors which has the one of the device numbers which is included in the detection signal obtained.

6. A route guiding system comprising:
approach detectors each of which is to perform entry detection processing of detecting entry of a facility user into a corresponding one of monitoring areas, and to output a detection signal including a device number which a corresponding one of the approach detectors has and identification information of the facility user who has entered the corresponding one of the monitoring areas, in each of the monitoring areas a corresponding one of the approach detectors is installed, the approach detectors having respective device numbers different from each other;
the guide display control apparatus according to claim 1; and
a display device to display the guide diagram in accordance with the display data generated by the display data generating circuitry of the guide display control apparatus.
